(19) United States
(12) Patent Application Publication
(10) Pub. No.: US 2012/0070534 A1
(43) Pub. Date: Mar. 22, 2012

(54) ALCOHOLIC BEVERAGE AND BEER-FLAVORED BEVERAGE EACH HAVING IMPROVED QUALITY OF TASTE AND METHOD OF PRODUCING THE SAME

(75) Inventor: Hajime Suzuki, Itami-shi (JP)

(73) Assignee: MATSUTANI CHEMICAL INDUSTRY CO., LTD., Itami-shi (JP)

(21) Appl. No.: 13/234,727

(22) Filed: Sep. 16, 2011

(30) Foreign Application Priority Data
Sep. 16, 2010 (JP) 2010-207940

(51) Int. Cl. C12C 12/02; A23L 2/56

(52) U.S. Cl. 426/11; 426/7; 426/592; 426/590

(57) ABSTRACT

An object of the present invention is to provide an alcoholic beverage or a beer-flavored beverage, each of which is well balanced in terms of flavor such as mellowness and savor, body (robustness and richness), and sharpness, and the deterioration smell of which generated during storage is improved. The method of producing an alcoholic beverage or a beer-flavored beverage, comprising adding an auxiliary material containing rare sugar or rare sugar syrup made from HFCS in the production of an alcoholic beverage or a beer-flavored beverage. The auxiliary material containing a rare sugar is that contains at least D-psicose, D-allose, or both D-psicose and D-allose.

### FIELD

The present invention relates to an alcoholic beverage or a beer-flavored beverage each of which is produced by adding a rare sugar-containing isomerized sugar (such as high fructose corn syrup (HFCS) containing rare sugar; rare sugar syrup made from HFCS) or a rare sugar as an auxiliary material in the production thereof, and is well balanced in terms of flavor and body and the deterioration smell of which generated during storage is improved, and also relates to a method of producing the same.

### BACKGROUND

Alcoholic beverages and beer-flavored beverages are highly luxury beverages, and therefore, in order to respond to consumers' demands as detailed as possible, a variety of products fitting into consumers' lifestyle have been placed in the market. On the other hand, due to an increase in awareness of lifestyle diseases typified by metabolic syndrome, an interest in foods contributing to the prevention or improvement of such diseases has been growing. Under such circumstances, in the categories of alcoholic beverages and beer-flavored beverages, a lot of products which suppress calorie intake or sugar intake, namely, “low-calorie”, “low-sugar”, and “no-sugar” products are commercially available.

However, as a means for obtaining a low-calorie or low-sugar alcoholic beverage or beer-flavored beverage, a method of substitute most of the sugars in the starting materials for assimilable sugars is generally used. As a result, the solid content in the resulting beverage are extremely decreased, and in most cases, a product which lacks flavor or body, is imbalanced in terms of quality of taste, and tastes like something is missing, namely, tastes “bad” is produced.

In order to improve the above disadvantages, various methods have been disclosed as a method of imparting a robust taste and a full body to an alcoholic beverage or a beer-flavored beverage to improve the quality of taste. For example, JP-A-11-127839 or JP-A-2003-47453 discloses a method of producing an alcoholic beverage or a brewed alcoholic beverage which has a flavor and a full body and has low calories by adding a no-calorie or low-calorie material such as acesulfame potassium, aspartame, erythritol, sorbitol, maltitol, or xylitol. JP-A-5-68529 discloses a method of adding isomalt oligosaccharide as a method of imparting a robust taste or a full body to an alcoholic beverage such as beer and a method of converting a fermentable sugar into isomalt oligosaccharide which is a non-fermentable sugar by adding α-glucosidase in a preparation step. Further, JP-A-2009-142233 discloses a method of using a water-soluble dietary fiber and a non-fermentable sugar in combination as a method of improving the flavor and body of a low-calorie beer-flavored alcoholic beverage.

However, by the addition of a high-intensity sweetener or a sugar alcohol as described in JP-A-11-127839 or JP-A-2003-47453, it is difficult to obtain a full body. In addition, the method has a problem that if such a material is added in an amount capable of imparting a full body, the sweetness stands out too much. Meanwhile, the method of adding isomalt oligosaccharide as described in JP-A-5-68529 has a problem in terms of low calorie or low sugar content because isomalt oligosaccharide is declared as a carbohydrate with 4 kilocalories per gram in the Nutrition Labeling Standards.

Further, the method of improving the quality of taste by using a water-soluble dietary fiber and a non-fermentable sugar in combination as disclosed in JP-A-2009-142233 is such that the concomitant use of two substances is an indispensable requirement, and in consideration of the labor required for mixing or the aspect of economic efficiency, the method is by no means a favorable method.

### SUMMARY

An object of the present invention is to provide an alcoholic beverage or a beer-flavored beverage, each of which is well balanced in terms of flavor such as mellowness and savor, body (robustness and richness), and sharpness, and the deterioration smell of which generated during storage is improved as compared with a conventional alcoholic beverage or beer-flavored beverage, particularly an alcoholic beverage or a beer-flavored beverage in pursuit of functionality of having low calories or low sugar content. Another object of the present invention is to provide a method of producing the same.

The present inventors made intensive studies to find a method of improving the balance with respect to flavor such as mellowness and savor, body (robustness and richness), and sharpness of an alcoholic beverage or a beer-flavored beverage, particularly an alcoholic beverage or a beer-flavored beverage characterized by having low calories or low sugar content, and found that in a process of producing an alcoholic beverage or a beer-flavored beverage, by adding a rare sugar-containing isomerized sugar (HFCS containing rare sugar) or a rare sugar as an auxiliary material, not only body, but also mellowness, sharpness, preferred sweetness and flavor can be imparted. Also, the present inventors unexpectedly found that according to this method, the deterioration smell of an alcoholic beverage or a beer-flavored beverage generated during long-term storage is reduced or avoided, and therefore, the smell is improved, namely, the method according to the present invention has a double effect, and thus completed the present invention.

That is, a gist of the present invention is a method of producing an alcoholic beverage or a beer-flavored beverage according to any of the following (1) to (8).

(1) A method of producing an alcoholic beverage or a beer-flavored beverage, comprising adding an auxiliary material containing rare sugar or rare sugar syrup made from HFCS in the production of an alcoholic beverage or a beer-flavored beverage.

(2) The method of producing an alcoholic beverage or a beer-flavored beverage according to the above (1), wherein the auxiliary material containing rare sugar is that contains at least D-psicose, D-allose, or both D-psicose and D-allose.

(3) The method of producing an alcoholic beverage or a beer-flavored beverage according to the above (1), wherein the auxiliary material is a rare sugar-containing isomerized sugar which is obtained by isomerizing one or more of the members selected from the group consisting of D-glucose, D-fructose and other isomerized sugars, with 0.005 mol/l or more of an alkali, which auxiliary material contains at least both D-psicose and D-allose, and less than 60% by mass of sugars other than D-glucose or D-fructose.

(4) The method of producing an alcoholic beverage or a beer-flavored beverage according to the above (1), wherein the produced alcoholic beverage or beer-flavored beverage contains rare sugar containing at least D-psicose, D-allose, or both D-psicose and D-allose, in an amount of from 0.1 to 20% by mass.

(5) The method of producing an alcoholic beverage or a beer-flavored beverage according to the above (1), wherein the alcoholic beverage is a beer.

(6) The method of producing an alcoholic beverage or a beer-flavored beverage according to the above (1), wherein the alcoholic beverage or beer-flavored beverage is a low-calorie beer-flavored alcoholic beverage or a low-calorie beer-flavored beverage.

(7) The method of producing an alcoholic beverage or a beer-flavored beverage according to the above (1), wherein the produced alcoholic beverage or beer-flavored beverage maintains or improves flavor (mellowness) peculiar to the alcoholic beverage or beer-flavored beverage, and has an excellent overall taste with respect to flavor (mellowness), body (robustness and richness), and sharpness.

(8) The method of producing an alcoholic beverage or a beer-flavored beverage according to the above (1), wherein the produced alcoholic beverage or beer-flavored beverage maintains or improves flavor (mellowness) peculiar to the alcoholic beverage or beer-flavored beverage, and has an excellent overall taste with respect to flavor (mellowness), body (robustness and richness) and sharpness, and the deterioration smell generated during storage is reduced or not detected.

Further, another gist of the present invention is an alcoholic beverage or a beer-flavored beverage according to the following (9) or (10).

(9) An alcoholic beverage or a beer-flavored beverage, which maintains or improves flavor (mellowness) peculiar to the alcoholic beverage or beer-flavored beverage, and has an excellent overall taste with respect to flavor (mellowness), body (robustness and richness), and sharpness, containing rare sugar containing at least D-psicose, D-allose, or both D-psicose and D-allose, in an amount of from 0.1 to 20% by mass.

(10) An alcoholic beverage or a beer-flavored beverage, which maintains or improves flavor (mellowness) peculiar to the alcoholic beverage or beer-flavored beverage, and has an excellent overall taste with respect to flavor (mellowness), body (robustness and richness), and sharpness, and the deterioration smell generated during storage is reduced or not detected, containing rare sugar containing at least D-psicose, D-allose, or both D-psicose and D-allose, in an amount of from 0.1 to 20% by mass.

The present invention can provide a method characterized by using an auxiliary material containing a rare sugar, with which favorable flavor (mellowness and savor), body (robustness and richness), and sharpness are imparted in a well-balanced manner to an alcoholic beverage or a beer-flavored beverage, particularly an alcoholic beverage or a beer-flavored beverage, which has a light flavor and a light body owing to the possession of functionality of having low calories or low sugar content, and also the deterioration smell of an alcoholic beverage or a beer-flavored beverage generated during long-term storage is reduced or avoided, thereby improving the smell. According to the present invention, not only can a double effect of reducing the risk of onset of lifestyle diseases and giving satisfaction in terms of taste be obtained, but also an advantage from the aspect of designing a product that a commercial product which is less likely to deteriorate over time is obtained can be obtained.

A rare sugar, particularly D-psicose and/or D-allose are/is used in a variety of applications (for example, for restriction of calorie intake in the case of obesity or the like, for suppression of increase in blood glucose level due to a disease such as diabetes, etc.) such as a diet sweetener, and has a characteristic as “a low-calorie sweetener”. Such a rare sugar does not have a problem of lack of robustness (also referred to as body or deep taste) unlike a high-intensity sweetener such as aspartame, stevia, acesulfame potassium, or sucralose, and has an advantage that the alcoholic beverage or beer-flavored beverage according to the present invention containing such a rare sugar maintains flavor (mellowness) peculiar to the alcoholic beverage or beer-flavored beverage, and has an excellent overall taste with respect to flavor (mellowness), body (robustness and richness), and sharpness. Further, the addition of a rare sugar not only imparts a full body to the alcoholic beverage or beer-flavored beverage, but also has an effect of reducing or avoiding the deterioration smell thereof such as an undesirable strange smell (so-called sunlight flavor) generated during storage due to the deterioration of components by masking the deterioration smell, whereby the smell thereof is improved.

### DETAILED DESCRIPTION

Hereinafter, the alcoholic beverage or beer-flavored beverage according to the present invention will be described.

The “alcoholic beverage” includes alcoholic beverages obtained through a fermentation step such as sake (Japanese wine), wine, fruit liquor, beer, a sparkling alcoholic beverage, or a beer-flavored fermented beverage (so-called “third beer” produced without using malt); distilled alcoholic beverages obtained through a fermentation step followed by a distillation step such as Shochu (Japanese distilled spirit), spirit, brandy, and whiskey; liqueurs such as a Shochu-based beverage, highball, sour, and plum liqueur; cocktails; and brewed seasonings such as sake for cooking and mirin (sweet sake for cooking).

The “beer-flavored beverage” is also called a “non-alcoholic beer”, a “non-alcoholic beer taste beverage”, or a “beer taste beverage”, and is generally referred to as a beer-flavored malt beverage having an alcohol content of less than 1%. As a method of producing the beer-flavored beverage, there are a method in which after completion of a fermentation step, a generated alcohol is removed, a method in which fermentation is performed such that an alcohol is not generated, a method of imparting a beer flavor to a soft drink, and the like, and any method can be used. Further, the beer-flavored beverage also includes products labeled as “carbonated drink” such as “Kirin Free” manufactured by Kirin Brewery Company, Limited.

The auxiliary material containing a rare sugar in the present invention will be described. First, there is no term of “auxiliary material” in the Liquor Tax Act in Japan, which defines the definitions of alcoholic beverages, classification thereof, the tax rates thereof, etc., and it is a term used for convenience for making the description easy to understand. The auxiliary material varies depending on the type of an alcoholic beverage or a beer-flavored beverage. For example, the auxiliary material to be used in sake refers to a raw material other than rice, koji (malted rice), and water. Examples of the auxiliary material to be used in sake include a brewing alcohol, and in addition the brewing alcohol, in the case of ordinary sake other than special-designation sake such as Ginjo sake and Honjozo sake, the use of a brewing sugar, succinic acid, citric acid, malic acid, sodium glutamate, or the like is permitted.

The fruit liquor is a brewed alcoholic beverage made from fruit juice, and is characterized by generally having a sour taste or a flavor of a fruit used as the raw material. In the classification of alcoholic beverages according to the Liquor Tax Act in Japan, the fruit liquor is defined as an alcoholic beverage obtained by the fermentation of a fruit as a raw material. Specific examples of the alcoholic beverage known as fruit liquor include wine (raw material fruit: grape), cider (raw material fruit: apple), and limoncello (raw material fruit: lemon). An alcoholic beverage obtained by distilling the thus produced fruit liquor to increase the alcohol content therein is called brandy. About a half amount of the sugar content (glucose, fructose, and sucrose) contained in fruit juice is converted into ethanol by the fermentation by yeast and the like. However, if the content of the resulting ethanol (alcohol content) is low, acetic fermentation is liable to be caused secondarily, and therefore, it is necessary to supplement a sugar at a stage before fermentation or add a neutral spirit after fermentation so as to adjust the alcohol content. The sugar supplementation for wine is performed for increasing the alcohol content in wine. The sugar to be used in the sugar supplementation for wine is sucrose inmost cases. In addition, as a raw material for the sugar supplementation, concentrated grape juice is used in some cases.

However, a mixed liquor produced by dipping a fruit in an alcoholic beverage such as a neutral spirit is generally called a “fruit liquor”. For example, plum liqueur, Chinese quince liqueur, and the like are categorized in fruit liquor of this type.

Further, as the auxiliary material (a raw material other than malt, hop, and water) which can be used in Japanese beer, wheat, rice, corn, kaoliang, potato, starch, a sugar, and a colorant (caramel) are defined in the Liquor Tax Act in Japan.

The sparkling alcoholic beverage is one of the alcoholic beverages defined in the Liquor Tax Act in Japan. In the Liquor Tax Act in Japan, the sparkling alcoholic beverage is defined in distinction from beer, and for example, even if fermentation is performed using malt, hop, and water as raw materials, an alcoholic beverage produced using a raw material other than the auxiliary materials defined in the Liquor Tax Act is not approved as beer and is classified into sparkling alcoholic beverages. Therefore, beer produced using spice or herb and fruit beer produced using fruit or fruit juice are classified into sparkling alcoholic beverages. A third beer is the name of a beer-flavored sparkling alcoholic beverage produced using a raw material other than those used in beer or sparkling alcoholic beverages by a production method other than those used in beer or sparkling alcoholic beverages. The term is made up by media since the third beer follows beer and sparkling alcoholic beverages. Alternatively, such a beer-flavored sparkling alcoholic beverage is also called “third draft beer”. In the present invention, as the auxiliary material of the alcoholic beverage or beer-flavored beverage as described above, an auxiliary material containing a rare sugar is used.

The “rare sugar” in the present invention is a “sugar that rarely exists in nature” according to the definition of International Society of Rare Sugars, and is a monosaccharide that exists only in a small amount in nature. In addition, the mass production thereof is difficult, and therefore, it is considered that there are a lot of unknown properties of a rare sugar remaining to be elucidated.

As a hexose, there are 16 types of aldoses including L-allose, L-gulose, L-glucose, L-galactose, L-altrose, L-idose, L-mannose, L-talose, D-talose, D-mannose, D-idose, D-altrose, D-galactose, D-glucose, D-gulose, and D-allose; and 8 types of ketoses including L-psicose, L-sorbose, L-fructose, L-tagasose, D-tagasose, D-fructose, D-sorbose, and D-psicose. Among these hexoses, as a monosaccharide that exists in a large amount in nature, there are 7 types of monosaccharides including D-glucose, D-fructose, D-galactose, D-mannose, D-ribose, D-xylose, and L-arabinose, and all of the other monosaccharides are rare sugars. The “rare sugar” in the present invention is not limited to these, and includes derivatives thereof, such as, sugar alcohols thereof, uronic acids thereof, amino sugars thereof.

Among the above-described rare sugars, D-psicose is a rare sugar which can be produced in a large amount at present. As a method of obtaining D-psicose, a production method in which fructose is treated with an enzyme (epimerase) to obtain D-psicose is generally used at present, however, D-psicose in the present invention is not limited thereto, and one obtained by a production method utilizing a microorganism which produces the enzyme or one extracted from a natural substance may be used, or a natural substance containing D-psicose may be used as such, or one obtained by isomerization through a chemical treatment method may be used. Incidentally, a method of purifying D-psicose utilizing an enzyme is disclosed in, for example, JP-A-6-125776 or the like.

On the other hand, D-allose is one of the rare sugars which have been tried to be produced in a large amount. As a method of obtaining D-allose, a method of synthesizing it from D-psicose using L-rhamnose isomerase (Journal of Fermentation and Bioengineering, Vol. 85, pp. 539 to 41 (1998)), or a method of obtaining it by allowing D-xylose isomerase to act on a solution containing D-psicose (JP-A-2002-17392 or the like) has been disclosed. However, D-allose in the present invention is not limited thereto, and D-allose obtained by any method, for example, one obtained by isomerization through a chemical treatment method or the like can be used.

The rare sugar-containing isomerized sugar (HFCS containing rare sugar) in the present invention is an isomerized sugar (HFCS) containing either of the above-described rare sugars, and the isomerized sugar (HFCS) is liquid sugar syrup containing glucose and fructose as main components. As a method of obtaining a rare sugar, several examples are already described, however, at present, there is almost no method with which a rare sugar can be obtained in a large amount at low cost. As a result of intensive studies, the present inventors succeeded in obtaining a rare sugar-containing isomerized sugar which contains a rare sugar in an amount of about 10% by mass at low cost by a relatively simple reaction method in which an isomerized sugar is isomerized with an alkali (International Patent Application No. PCT/JP2010/5536). In the course of completing the present invention, it was found that in the sugar composition of the rare sugar-containing isomerized sugar studied, the identified rare sugars are D-psicose (0.5 to 17% by mass) and D-allose (0.2 to 10% by mass), and other than these, also unidentified rare sugars exist, and the rare sugars according to the present invention include these unidentified rare sugars. Further, it is found that the rare sugar-containing isomerized sugar contains D-mannose, which is not a rare sugar, in an amount of from 0.5 to 40% by mass.

On the other hand, if the isomerization reaction is allowed to proceed until the concentration of D-glucose and D-fructose is reduced to about 40% by mass, browning of the isomerized sugar proceeds significantly, and therefore, it is difficult to industrially apply the resulting product. Accordingly, the content of sugars other than D-glucose and D-fructose is preferably less than 60% by mass.

The rare sugar-containing isomerized sugar in the present invention is not limited to those obtained by the above-described method, and one obtained by another method may be used, or the rare sugars contained therein are not limited only to D-psicose and D-allose which have been identified so far.

In the case of, for example, beer, the above-described auxiliary material generally makes the taste of beer mild or clean, and therefore, the consumer can enjoy a taste different from that of beer produced without using the auxiliary material. In addition, the auxiliary material is also useful for controlling the flavor, fermentation degree, or the like of beer or adjusting the foaming of beer. In Japan, as a raw material of beer, rice has been used for a long time. Rice has a high content of starch and is used as a raw material for starch supplementation. Corn to be used as the auxiliary material is a material obtained by grinding corn, and starch to be used as the auxiliary material is starch derived from corn, and both materials have a role of make the taste of beer clean, and also have a function to adjust the flavor of beer. Representative examples of the sugar to be used as the auxiliary material include corn syrup. Corn syrup is produced by liquefying and saccharifying corn starch with an enzyme, followed by filtration, decolorization, condensation, and so on, and it is possible to control the flavor, fermentation degree, or the like of the final product by changing the sugar composition.

In the present invention, by using an auxiliary material containing a rare sugar as the auxiliary material, an alcoholic beverage or a beer-flavored beverage which maintains or improves flavor (mellowness) peculiar to the alcoholic beverage or beer-flavored beverage, and has an excellent overall taste with respect to flavor (mellowness), body (robustness and richness), and sharpness can be produced. Further, the deterioration smell thereof such as an undesirable strange smell (so-called sunlight flavor) generated during storage by the deterioration of components can be reduced or avoided by masking the deterioration smell, whereby the smell thereof can be improved.

The quality of taste is composed of sweetness, umami, saltiness, sourness, and bitterness. Each monosaccharide classified into rare sugars has a distinctive quality of taste, and there are no sugars having the same quality of taste. It is preferred that the alcoholic beverage or the like having an improved quality of taste and the like according to the present invention contains at least D-allose and/or D-psicose in an appropriate amount, and it is considered that the rare sugar component added apparently has a favorable effect on the improvement of the quality of taste of the alcoholic beverage or beer-flavored beverage (impartment of a flavor and a full body). By incorporating a rare sugar other than D-allose and/or D-psicose or a sugar, a high-intensity sweetener, or the like within a range that does not adversely affect the quality, an alcoholic beverage or the like having a better quality of taste and the like can be obtained. In the case of using a rare sugar-containing isomerized sugar, the type or amount of a rare sugar to be produced by the isomerization varies depending on a reaction condition or the like of the isomerization with an alkali, and therefore, it is possible to improve the flavor or taste of the alcoholic beverage or the like by utilizing the difference in the reaction condition. Further, in the method of producing an alcoholic beverage or a beer-flavored beverage, the addition of the auxiliary material containing a rare sugar may be performed in a preparation step, a fermentation step, or a step after completion of fermentation.

In the case where an alcoholic beverage is produced by adding the rare sugar-containing isomerized sugar in the course of a fermentation step of the alcoholic beverage, the majority portion (glucose and fructose) of the isomerized sugar, D-mannose, and the like are assimilated by yeast, and a rare sugar portion is not assimilated by yeast and remains as such in the alcoholic beverage. From this fact, it is considered that in the case of a fermented alcoholic beverage, this rare sugar component apparently has a favorable effect on the improvement of the quality of taste of the alcoholic beverage (impartment of a flavor and a full body). In addition, when the alcoholic beverage or the like obtained according to the present invention is stored for a long term, a strange taste or a strange smell (deterioration smell), which is generated in the case of using a conventional method, is improved (masked or reduced). From this fact, it is considered that the rare sugar portion also largely contributes to this effect. Further, also in the case where fermentation is not performed, the rare sugar-containing isomerized sugar contains a variety of sugars having a different quality of sweetness or a different physical property, and therefore, it is considered that such sugars have a favorable effect in the same manner.

In the method of producing an alcoholic beverage or a beer-flavored beverage having an improved quality of taste according to the present invention, the using amount of the auxiliary material containing a rare sugar necessary for improving the quality of taste is not particularly limited as long as a desired effect can be obtained, however, there is a preferred concentration of the auxiliary material according to the type of an alcoholic beverage or a beer-flavored beverage. For example, in the case of beer, a beer-flavored beverage, or the like, which does not originally have sweetness, by adding the auxiliary material such that the total amount of D-psicose and D-allose based on the amount of the final product is from 0.1 to 5.0% by mass, preferably from 0.5 to 2.0% by mass, the effect of improving the quality of taste and deterioration smell can be effectively obtained. If the amount of the rare sugars in the final product is less than 0.1% by mass, the effect of improving the quality of taste is not sufficient, and therefore, the amount thereof is preferably 0.5% by mass or more. Meanwhile, if the amount thereof exceeds 5.0% by mass, although there is no problem for alcoholic beverages and the like which originally have high sweetness such as mirin and liqueur, high sweetness is imparted to alcoholic beverages and the like other than these sweet alcoholic beverages to deteriorate the overall taste balance, and also from the economic point of view, the amount thereof is preferably determined to be up to 2.0% by mass.

In the case of an alcoholic beverage or the like which originally has high sweetness such as mirin or liqueur, the rare sugar may be contained in an amount of about 40% by mass, however, from the economic point of view, and also in consideration of the concentration of sugars which originally contained in a conventional sweet alcoholic beverage or the like, it is preferred that the rare sugar is incorporated in the final product in an amount of from about 0.5 to 20% by mass.

Further, the effect of the present invention can be obtained in any type of an alcoholic beverage or a beer-flavored beverage, however, the effect is significantly obtained in particularly so-called beverages and the like which lack flavor or body in the category of low-calorie or low-sugar alcoholic beverage or beer-flavored beverage.

The thus obtained alcoholic beverage or beer-flavored beverage is well balanced in terms of body and flavor, and also the deterioration smell thereof generated during long-term storage is improved. Further, in the case where the present invention is applied to a low-calorie or low-sugar alcoholic beverage or beer-flavored beverage, both health aspect and luxury aspect can be achieved, and therefore, the present invention has a very high value from the viewpoint of industrial application.

Hereinafter, the present invention will be more specifically described with reference to Examples, however, the technical scope of the present invention is not limited to these examples. Incidentally, the symbol represented by “%” in Examples is “% by mass” in all cases unless otherwise specified.

### Example 1

### Sparkling Alcoholic Beverage Obtained Using Rare Sugar-Containing Isomerized Sugar

### [Brewing Procedure and Sugar Composition of Resulting Sparkling Alcoholic Beverage]

By using a rare sugar-containing isomerized sugar, a sparkling alcoholic beverage was brewed using a small amount of malt. The composition at the time of preparation is shown in Table 1.

In this Example, malt extract was used in place of malt which should originally be used. The malt extract is equivalent to wort obtained by saccharifying malt, followed by boiling and condensation. Incidentally, about 14 g of malt extract corresponds to 10 g of malt.

Further, the rare sugar-containing isomerized sugar used was one obtained by subjecting a commercially available isomerized sugar (fructose content: 42%) to alkali isomerization using a 0.6 N NaOH solution, and contained D-psicose and D-allose in an amount of about 10%. This rare sugar-containing isomerized sugar was blended such that the total amount of D-psicose and D-allose contained in a finally obtained fermentation solution was 0.1%, 0.5%, or 1.0%.

TABLE 1
Addition amount per liter of solution before fermentation (g)

| Components of | Comparative | Example | Example | Example |
|---|---|---|---|---|
| fermentation | example 1 | 1-(1) | 1-(2) | 1-(3) |
| stock solution | (control) | (0.1%)*¹ | (0.5%)*¹ | (1.0%)*¹ |
| Malt extract | 2.0 | 2.0 | 2.0 | 2.0 |
| Isomerized sugar | 141.5 | 128.7 | 77.2 | 14.1 |
| (Brix: 70.7)*² | | | | |
| Rare sugar- | — | 13.4 | 66.7 | 133.4 |
| containing isomerized | | | | |
| sugar (Brix: 75.0)*² | | | | |
| Hop extract | 1.6 | 1.6 | 1.6 | 1.6 |
| Yeast | 0.6 | 0.6 | 0.6 | 0.6 |
| (dried Ale yeast)) | | | | |

*¹The numerical value in the parenthesis is the final concentration of D-psicose and D-allose in the fermentation solution (the same shall apply to the following tables).
*²The amount was set such that the total addition amount of the isomerized sugars was 100 g in terms of solid content.

The components shown in Table 1 were mixed, and the resulting mixture was boiled at 80° C. for 30 minutes, followed by filtration through nylon cloth and diatomaceous earth. Yeast was added to the resulting filtrate, and fermentation by the yeast was performed at 20° C. for 10 days. Thereafter, sugar was added in an amount of 6 g per liter of the fermentation solution, and fermentation was further performed at 20° C. for 14 days, whereby a sparkling alcoholic beverage was obtained. The thus obtained sparkling alcoholic beverage was subjected to ethanol removal and desalting according to a conventional procedure. Then, the sugar composition was analyzed by high-performance liquid chromatography (HPLC). The results are shown in Table 2.

TABLE 2
Amount of remaining sugars per 100 g
of sparkling alcoholic beverage (g)

| | Comparative | Example | Example | Example |
|---|---|---|---|---|
| | example 1 | 1-(1) | 1-(2) | 1-(3) |
| Sugar composition | (control) | (0.1%) | (0.5%) | (1.0%) |
| Trisaccharide or | 0.12 | 0.11 | 0.13 | 0.12 |
| higher saccharide | | | | |
| Disaccharide | 0.03 | 0.03 | 0.03 | 0.03 |
| D-glucose | 0.01 | 0.02 | 0.03 | 0.05 |
| D-allose | 0.00 | 0.07 | 0.13 | 0.22 |
| D-psicose | 0.01 | 0.11 | 0.31 | 0.54 |
| Other sugars | 0.32 | 0.41 | 0.75 | 1.01 |

From the above results, the amount of remaining D-psicose and D-allose was found to be close to the designed value. On the other hand, the amount of the other sugars contained in Example 1-(1), 1-(2), or 1-(3) was larger as compared with the case of control, and therefore, it was presumed that a hardly assimilable sugar other than D-allose and D-psicose was contained. This indicates that the rare sugar-containing isomerized sugar contains a rare sugar other than D-allose and D-psicose, and therefore, an effect of improving the quality of taste by a plurality of rare sugars could be expected.

[Sensory Evaluation Immediately after Brewing]

Each of the sparkling alcoholic beverages after brewing was evaluated by 6 panelists in terms of body (robustness and richness), flavor (mellowness), and sharpness.

The panelists were given an explanation for the evaluation items as follows: the “robustness” is “a sense of good taste remaining in the mouth”; the “richness” is “a sense of expansion” expanding when a sip of the sparkling alcoholic beverage is taken; the “mellowness” is “a flavor peculiar to an alcoholic beverage or a beer-flavored beverage” when a sip of the sparkling alcoholic beverage is taken; and the “sharpness” is “a clean aftertaste”.

The evaluation was performed on a scale of 1 to 5 as follows: the case where the quality of taste of each item was significantly deteriorated was evaluated as 1; the case where the quality of taste of each item was somewhat deteriorated was evaluated as 2; the case where no obvious deterioration or improvement was observed was evaluated as 3; the case where the quality of taste of each item was somewhat improved was evaluated as 4; and the case where the quality of taste of each item was significantly improved was evaluated as 5. The results are shown in the following Table 3.

TABLE 3

| | Comparative | Example | Example | Example |
|---|---|---|---|---|
| | example 1 | 1-(1) | 1-(2) | 1-(3) |
| Evaluation item | (control) | (0.1%) | (0.5%) | (1.0%) |
| Body (robustness | 1.4 | 2.4 | 3.8 | 3.7 |
| and richness) | | | | |
| Flavor (mellowness) | 1.3 | 2.5 | 3.7 | 3.8 |
| Sharpness | 1.2 | 2.2 | 3.3 | 3.5 |

In Comparative example 1 (control), the scores for all the evaluation items were low and the quality of taste was low. On the other hand, in the sparkling alcoholic beverages obtained by adding the rare sugar-containing isomerized sugar of Examples 1-(1), 1-(2), and 1-(3), the scores for all the evaluation items were higher than those of Comparative example 1.

In Example 1-(1), the effect of improving the quality of taste was apparently observed, however, the effect was not so large. Meanwhile, in Examples 1-(2) and 1-(3), the effect of improving the quality of taste was significantly increased. Incidentally, in Example 1-(3), a dramatic effect of improving the quality of taste higher than that obtained in Example 1-(2) was not observed.

That is, it was found that when the total amount of remaining D-psicose and D-allose is 0.5% or more, the quality of taste is most improved, and an excellent overall taste with respect to flavor (mellowness), body (robustness and richness), and sharpness can be obtained.

[Sensory Evaluation after Accelerated Test]

Sparkling alcoholic beverages produced according to the composition shown in Table 1 were subjected to an accelerated test by being left stand at 37° C. for 72 hours. Then, comparative evaluation was performed by 6 panelists in terms of the quality of taste (robustness, flavor, and sharpness) and the smell of the samples between before and after the accelerated test.

The panelists were given an explanation for the smell as follows: the “smell” is evaluated as to whether the smell is worsened due to deterioration smell by a storage test. The effect of the deterioration smell on the mellowness peculiar to an alcoholic beverage or a beer-flavored beverage is evaluated.

The evaluation was performed on a scale of 1 to 5 as follows: as compared with the sparkling alcoholic beverage before the accelerated test, the case where the quality of taste of each item was significantly deteriorated was evaluated as 1; the case where the quality of taste of each item was somewhat deteriorated was evaluated as 2; the case where no deterioration was observed was evaluated as 3; the case where the quality of taste of each item was somewhat improved was evaluated as 4; and the case where the quality of taste of each item was significantly improved was evaluated as 5. The results are shown in the following Table 4.

TABLE 4

| | Comparative | Example | Example | Example |
|---|---|---|---|---|
| | example 1 | 1-(1) | 1-(2) | 1-(3) |
| Evaluation item | (control) | (0.1%) | (0.5%) | (1.0%) |
| Quality of taste (body, | 1.3 | 2.0 | 2.8 | 2.7 |
| flavor(mellowness), | | | | |
| and sharpness) | | | | |
| Smell | 1.0 | 1.7 | 2.7 | 2.8 |

In Comparative example 1 (control), the scores for all the evaluation items were low. On the other hand, in Examples 1-(1), 1-(2), and 1-(3), the scores for all the evaluation items were higher than those of Comparative example 1, and a tendency was observed that the deterioration of the quality of taste and the smell was suppressed. Also with respect to the effect of improving the storage stability of these beverages of Examples 1-(1), 1-(2), and 1-(3), in Example 1-(1), an improving effect was slightly observed, however, in Example 1-(2), a significant improving effect was observed. Further, in Example 1-(3), although an improving effect (an effect of improving smell by reducing or avoiding deterioration smell generated during storage) similar to that obtained in Example 1-(2) was observed, a dramatic improving effect higher than that obtained in Example 1-(2) was not observed.

### Example 2

### Sparkling Alcoholic Beverage Obtained Using D-Psicose

### [Brewing Procedure and Sugar Composition of Resulting Sparkling Alcoholic Beverage]

By using D-psicose, a sparkling alcoholic beverage was brewed using a small amount of malt. The composition at the time of preparation is shown in Table 5.

In this Example, malt extract was used in place of malt. The malt extract is equivalent to wort obtained by saccharifying malt, followed by boiling and condensation. Incidentally, about 14 g of malt extract corresponds to 10 g of malt.

As the D-psicose, a commercially available product (purity: 98% or more) was used, and designing was performed such that the amount of D-psicose contained in a finally obtained fermentation solution was 0.1%, 0.5%, or 1.0%.

TABLE 5
Addition amount per liter of solution before fermentation (g)

| Components of | Comparative | Example | Example | Example |
|---|---|---|---|---|
| fermentation | example 2*² | 2-(1) | 2-(2) | 2-(3) |
| stock solution | (control) | (0.1%) | (0.5%) | (1.0%) |
| Malt extract | 2.0 | 2.0 | 2.0 | 2.0 |
| Isomerized sugar | 141.5 | 141.5 | 141.5 | 141.5 |
| (Brix: 70.7)*¹ | | | | |
| D-psicose | — | 1.0 | 5.0 | 10.0 |
| Hop extract | 1.6 | 1.6 | 1.6 | 1.6 |
| Yeast | 0.6 | 0.6 | 0.6 | 0.6 |
| (dried Ale yeast)) | | | | |

*¹The amount was set such that the addition amount of the isomerized sugar was 100 g in terms of solid content.
*²The compositional percentages were the same as those in Comparative example 1.

The components shown in Table 5 were mixed, and the resulting mixture was boiled at 80° C. for 30 minutes, followed by filtration through nylon cloth and diatomaceous earth. Yeast was added to the resulting filtrate, and fermentation by the yeast was performed at 20° C. for 10 days. Thereafter, sugar was added in an amount of 6 g per liter of the fermentation solution, and fermentation was further performed at 20° C. for 14 days, whereby a sparkling alcoholic beverage was obtained. The thus obtained sparkling alcoholic beverage was subjected to ethanol removal and desalting according to a conventional procedure. Then, the sugar composition was analyzed by high-performance liquid chromatography (HPLC). The results are shown in Table 6.

TABLE 6
Amount of remaining sugars per 100 g
of sparkling alcoholic beverage (g)

| | Comparative | Example | Example | Example |
|---|---|---|---|---|
| | example 2 | 2-(1) | 2-(2) | 2-(3) |
| Sugar composition | (control) | (0.1%) | (0.5%) | (1.0%) |
| Trisaccharide or | 0.12 | 0.12 | 0.12 | 0.11 |
| higher saccharide | | | | |
| Disaccharide | 0.05 | 0.04 | 0.05 | 0.04 |
| D-glucose | 0.01 | 0.01 | 0.05 | 0.02 |
| D-allose | 0.00 | 0.00 | 0.00 | 0.00 |
| D-psicose | 0.00 | 0.09 | 0.41 | 0.88 |
| Other sugars | 0.36 | 0.43 | 0.32 | 0.46 |

From the above results, the amount of remaining D-psicose was found to be close to the designed value. Accordingly, it was found that almost all the amount of D-psicose remained without being assimilated.

[Sensory Evaluation Immediately after Brewing]

Each of the resulting sparkling alcoholic beverages was evaluated by 6 panelists in terms of robustness, mellowness, and richness. The evaluation was performed on a scale of 1 to 5 as follows: the case where the quality of taste of each item was significantly deteriorated was evaluated as 1; the case where the quality of taste of each item was somewhat deteriorated was evaluated as 2; the case where no obvious deterioration or improvement was observed was evaluated as 3; the case where the quality of taste of each item was somewhat improved was evaluated as 4; and the case where the quality of taste of each item was significantly improved was evaluated as 5. The results are shown in the following Table 7.

TABLE 7

| | Comparative | Example | Example | Example |
|---|---|---|---|---|
| | example 2 | 2-(1) | 2-(2) | 2-(3) |
| Evaluation item | (control) | (0.1%) | (0.5%) | (1.0%) |
| Body (robustness | 1.3 | 2.4 | 3.8 | 3.7 |
| and richness) | | | | |
| Flavor | 1.5 | 2.8 | 3.8 | 3.6 |
| (mellowness) | | | | |
| Sharpness | 1.3 | 2.7 | 4.0 | 3.8 |

In Comparative example 2 (control), the scores for all the evaluation items were low. On the other hand, in the sparkling alcoholic beverages obtained by brewing using D-psicose of Examples 2-(1), 2-(2), and 2-(3), the scores for all the evaluation items were higher than those of Comparative example 2. Further, in Example 2-(1), the effect of improving the quality of taste was not so large, however, in Examples 2-(2) and 2-(3), the quality of taste was significantly improved. Incidentally, in Example 2-(3), a dramatic effect of improving the quality of taste higher than that obtained in Example 2-(2) was not observed. That is, it was found that when D-psicose is added in an amount of 0.5% or more, the quality of taste is most improved.

[Sensory Evaluation after Accelerated Test]

Sparkling alcoholic beverages produced according to the composition shown in Table 5 were subjected to an accelerated test by being left stand at 37° C. for 72 hours. Then, comparative evaluation was performed by 6 panelists in terms of the quality of taste (robustness, mellowness, and sharpness) and the smell of the samples between before and after the accelerated test. The evaluation was performed on a scale of 1 to 5 as follows: as compared with the sparkling alcoholic beverage before the accelerated test, the case where the quality of taste of each item was significantly deteriorated was evaluated as 1; the case where the quality of taste of each item was somewhat deteriorated was evaluated as 2; the case where no deterioration was observed was evaluated as 3; the case where the quality of taste of each item was somewhat improved was evaluated as 4; and the case where the quality of taste of each item was significantly improved was evaluated as 5. The results are shown in the following Table 8.

TABLE 8

| | Comparative | Example | Example | Example |
|---|---|---|---|---|
| | example 2 | 2-(1) | 2-(2) | 2-(3) |
| Evaluation item | (control) | (0.1%) | (0.5%) | (1.0%) |
| Quality of taste (body, | 1.8 | 2.2 | 2.5 | 2.7 |
| flavor(melloness), and | | | | |
| sharpness) | | | | |
| Smell | 1.0 | 2.0 | 2.7 | 2.8 |

In Comparative example 2 (control), the scores for all the evaluation items were low. On the other hand, in the sparkling alcoholic beverages obtained by adding D-psicose of Examples 2-(1), 2-(2), and 2-(3), the scores for all the evaluation items were higher than those of Comparative example 2, that is, a tendency was observed that the deterioration of the quality of taste and the smell after the accelerated test was suppressed in the case of the sparkling alcoholic beverages obtained by adding D-psicose. With respect to the effect of improving the storage stability of these beverages of Examples 2-(1), 2-(2), and 2-(3), in the same manner as the results of Example 1, in Example 2-(1), a large improving effect was not obtained, however, in Examples 2-(2) and 2-(3), a significant improving effect was observed. Incidentally, in Example 2-(3), a dramatic improving effect higher than that obtained in Example 2-(2) was not observed.

### Example 3

### Sparkling Alcoholic Beverage Obtained Using Rare Sugar and Sparkling Alcoholic Beverage Obtained Using Sugar Alcohol

### [Brewing Procedure and Sugar Composition of Resulting Sparkling Alcoholic Beverage]

In JP-A-11-127839 and JP-A-2003-47453, for the purpose of improving the lost flavor and body of a low-calorie brewed alcoholic beverage, a no-calorie or low-calorie material such as acesulfame potassium, aspartame, erythritol, sorbitol, maltitol, or xylitol is used. Therefore, in order to compare the effect of such a material on the quality of taste of a brewed alcoholic beverage with the effect of a rare sugar thereon, a comparative test was performed by brewing a sparkling alcoholic beverage. The composition at the time of preparation is shown in the following Table 9.

In this Example, malt extract was used in place of malt. The malt extract is equivalent to wort obtained by saccharifying malt, followed by boiling and condensation. Incidentally, about 14 g of malt extract corresponds to 10 g of malt.

As the sugar which is hardly assimilable and has an effect on the quality of taste, a sugar alcohol (sorbitol), the rare sugar-containing isomerized sugar used in Example 1, and D-psicose used in Example 2 were used separately. Designing was performed such that the amount of each sugar contained in a finally obtained sparkling alcoholic beverage was 0.5% (in the case of the rare sugar-containing isomerized sugar, the total amount of D-psicose and D-allose therein was 0.5%).

TABLE 9
Addition amount per liter of solution before fermentation (g)

| Components of | Comparative | Comparative | Example 3-(1) | Example |
|---|---|---|---|---|
| fermentation | example 3-(1) | example 3-(2) | (rare sugar-containing | 3-(2) |
| stock solution | (control) | (sorbitol) | isomerized sugar) | (D-psicose) |
| Malt extract | 2.0 | 2.0 | 2.0 | 2.0 |
| Isomerized sugar | 141.5 | 141.5 | 128.7 | 141.5 |
| (Brix: 70.7)*¹ | | | | |
| Sorbitol | | 5.0 | | |
| Rare sugar-containing | | | 13.4 | |
| isomerized sugar | | | | |
| (Brix: 75.0)*¹ | | | | |
| D-psicose | | | | 5.0 |
| Hop extract | 1.6 | 1.6 | 1.6 | 1.6 |
| Yeast | 0.6 | 0.6 | 0.6 | 0.6 |
| (dried Ale yeast)) | | | | |

*¹The amount was set such that the total addition amount of the isomerized sugars was 100 g in terms of solid content.

The components shown in Table 9 were mixed, and the resulting mixture was boiled at 80° C. for 30 minutes, followed by filtration through nylon cloth and diatomaceous earth. Yeast was added to the resulting filtrate, and fermentation by the yeast was performed at 20° C. for 10 days. Thereafter, sugar was added in an amount of 6 g per liter of the fermentation solution, and fermentation was further performed at 20° C. for 14 days, whereby a sparkling alcoholic beverage was obtained. The thus obtained sparkling alcoholic beverage was subjected to ethanol removal and desalting according to a conventional procedure. Then, the sugar composition was analyzed by high-performance liquid chromatography (HPLC). The results are shown in the following Table 10.

TABLE 10
Amount of remaining sugars per 100 g of sparkling alcoholic beverage (g)

| | Comparative | Comparative | Example 3-(1) | Example |
|---|---|---|---|---|
| | example 3-(1) | example 3-(2) | (rare sugar-containing | 3-(2) |
| Sugar composition | (control) | (sorbitol) | isomerized sugar) | (D-psicose) |
| Trisaccharide or | 0.11 | 0.12 | 0.12 | 0.11 |
| higher saccharide | | | | |
| Disaccharide | 0.02 | 0.02 | 0.02 | 0.02 |
| D-glucose | 0.01 | 0.01 | 0.04 | 0.02 |
| D-allose | 0.00 | 0.00 | 0.12 | 0.00 |
| D-psicose | 0.01 | 0.01 | 0.28 | 0.43 |
| Sorbitol | 0.00 | 0.47 | 0.00 | 0.00 |
| Other sugars | 0.36 | 0.36 | 0.77 | 0.39 |

In Comparative example 3-(2), Example 3-(1), and Example 3-(2), sorbitol, rare sugars, and D-psicose remained, respectively, in an amount of about 0.5%, which was close to the designed value. That is, it was found that any of these sugars added at the time of preparation remained in the resulting brewed alcoholic beverage without being assimilated by yeast.

[Sensory Evaluation Immediately after Brewing]

Each of the resulting sparkling alcoholic beverages was evaluated by 6 panelists in terms of robustness, mellowness, and richness. The evaluation was performed on a scale of 1 to 5 as follows: the case where the quality of taste of each item was significantly deteriorated was evaluated as 1; the case where the quality of taste of each item was somewhat deteriorated was evaluated as 2; the case where no obvious deterioration or improvement was observed was evaluated as 3; the case where the quality of taste of each item was somewhat improved was evaluated as 4; and the case where the quality of taste of each item was significantly improved was evaluated as 5. The results are shown in the following Table 11.

TABLE 11

| | Comparative | Comparative | Example 3-(1) | Example |
|---|---|---|---|---|
| | example 3-(1) | example 3-(2) | (rare sugar-containing | 3-(2) |
| Evaluation item | (control) | (sorbitol) | isomerized sugar) | (D-psicose) |
| Body | 1.2 | 4.0 | 4.2 | 4.0 |
| (robustness and | | | | |
| richness) | | | | |
| Flavor | 1.3 | 3.0 | 3.8 | 3.8 |
| (mellowness) | | | | |
| Sharpness | 1.3 | 2.5 | 4.2 | 3.2 |

In each of Comparative example 3-(2) (sorbitol), Example 3-(1) (rare sugar-containing isomerized sugar), and Example 3-(2) (D-psicose), the quality of taste was improved as compared with the case of Comparative example 3-(1) (control). However, in the case of using the rare sugar-containing isomerized sugar or D-psicose, both mellowness and richness could be strongly felt, however, in the case of using sorbitol, a tendency of lacking mellowness and richness was observed. It was presumed that this difference is attributed to an apparent difference in the quality of sweetness between the sugar alcohol and the rare sugars, and it was indicated that the rare sugars such as D-psicose have an excellent effect of imparting robustness, mellowness, and richness to a brewed alcoholic beverage.

[Sensory Evaluation after Accelerated Test]

Sparkling alcoholic beverages produced according to the composition shown in Table 9 were subjected to an accelerated test by being left stand at 37° C. for 72 hours. Then, comparative evaluation was performed by 6 panelists in terms of the quality of taste (robustness, mellowness, and sharpness) and the smell of the samples between before and after the accelerated test. The evaluation was performed on a scale of 1 to 5 as follows: as compared with the sparkling alcoholic beverage before the accelerated test, the case where the quality of taste of each item was significantly deteriorated was evaluated as 1; the case where the quality of taste of each item was somewhat deteriorated was evaluated as 2; the case where no deterioration was observed was evaluated as 3; the case where the quality of taste of each item was somewhat improved was evaluated as 4; and the case where the quality of taste of each item was significantly improved was evaluated as 5. The results are shown in the following Table 12.

TABLE 12

| | Comparative | Comparative | Example 3-(1) | Example |
|---|---|---|---|---|
| | example 3-(1) | example 3-(2) | (rare sugar-containing | 3-(2) |
| Evaluation item | (control) | (sorbitol) | isomerized sugar) | (D-psicose) |
| Quality of taste (body, | 1.5 | 1.5 | 2.7 | 2.8 |
| flavor(mellowness), | | | | |
| and sharpness) | | | | |
| Smell | 1.3 | 2.0 | 2.8 | 2.8 |

In Comparative example 3-(1) (control), the scores for all the evaluation items were low, and in Comparative example 3-(2) (sorbitol), as apparent from the scores, almost no effect of improving the deterioration of the quality of taste or the smell was observed. On the other hand, in the sparkling alcoholic beverages of Examples 3-(1) and 3-(2) obtained by adding the rare sugar-containing isomerized sugar or D-psicose, a tendency was observed that the deterioration of the quality of taste and the smell was reduced.

### Example 4

### Plum Liqueur Obtained by Using Rare Sugar (1)

### [Preparation Procedure]

Conventionally, when plum liqueur is prepared, sugar is used for imparting sweetness and also for extracting plum extract utilizing osmotic pressure in most cases. In order to study the effect of partially replacing this sugar by a rare sugar-containing isomerized sugar or D-psicose on the quality of taste, plum liqueur was prepared. Raw materials were mixed according to the composition shown in the following Table 13 such that in the case of Example 4-(1), the total amount of D-allose and D-psicose was 1.5%, and in the case of Example 4-(2), the amount of D-psicose was 1.5%, and then, the resulting mixture was matured at room temperature for 6 months.

TABLE 13
Addition amount per 3.6 liters of Shochu

| | Comparative | Example 4-(1) | Example |
|---|---|---|---|
| | example 4 | (rare sugar-containing | 4-(2) |
| Raw materials | (control) | isomerized sugar) | (D-psicose) |
| Plum | 2.0 kg | 2.0 kg | 2.0 kg |
| Rock sugar candy | 1.0 kg | — | 0.9 kg |
| Rare sugar- | — | 1.0 kg | |
| containing | | | |
| isomerized sugar | | | |
| D-psicose | — | — | 0.1 kg |
| Shochu | 3.6 L | 3.6 L | 3.6 L |

[Sensory Evaluation Immediately after Maturation]

Each of the resulting plum liqueurs was evaluated by 6 panelists in terms of quality of taste (robustness, mellowness, and richness). The evaluation was performed on a scale of 1 to 5 as follows: as compared with the case of Comparative example 4 (control), the case where the quality of each taste was significantly deteriorated was evaluated as 1; the case where the quality of each taste was somewhat deteriorated was evaluated as 2; the case where the quality of each taste was equivalent was evaluated as 3; the case where the quality of each taste was somewhat favorable was evaluated as 4; and the case where the quality of each taste was significantly favorable was evaluated as 5. The results are shown in the following Table 14.

TABLE 14

| | Comparative | Example 4-(1) | Example |
|---|---|---|---|
| | example 4 | (rare sugar-containing | 4-(2) |
| Evaluation item | (control) | isomerized sugar) | (D-psicose) |
| Robustness | 3.0 | 4.5 | 3.2 |
| Mellowness | 3.0 | 4.8 | 3.0 |
| Richness | 3.0 | 4.7 | 3.3 |

As apparent from the obtained scores, it was found that by adding the rare sugar-containing isomerized sugar, the quality of each taste becomes favorable (Example 4-(1)).

On the other hand, the quality of taste of the plum liqueur obtained by adding D-psicose alone (Example 4-(2)) was substantially equivalent to that in the case of Comparative example 4 (control). Therefore, it was indicated that not only D-allose and D-psicose contained in the rare sugar-containing isomerized sugar, but also other sugars interact with one another and have a favorable effect on the quality of taste.

### Example 5

### Plum Liqueur Obtained by Using Rare Sugar (2)

### [Preparation Procedure]

Although the plum liqueur of Example 4-(2) contained D-psicose in an amount of 1.5%, an effect was not obtained as expected. It is considered that this is because the concentration of D-psicose was low as compared with the concentration of sugar in the original plum liqueur, which is high. Accordingly, in order to study the effect of replacing the total amount of the rock sugar candy in Example 4 by D-psicose on the quality of taste, plum liqueur was prepared by mixing raw materials according to the composition shown in the following Table 15. The maturation was performed at room temperature for 6 months.

TABLE 15
Addition amount per 3.6 liters of Shochu

| | Comparative | Example |
|---|---|---|
| | example 4*¹ | 4-(3) |
| Raw materials | (control) | (D-psicose) |
| Plum | 2.0 kg | 2.0 kg |
| Rock sugar candy | 1.0 kg | |
| Rare sugar- | | |
| containing | | |
| isomerized sugar | | |
| D-psicose | | 1.0 kg |
| Shochu | 3.6 L | 3.6 L |

*¹It is the same as Comparative example 4 in Table 14.

[Sensory Evaluation Immediately after Maturation]

Each of the resulting plum liqueurs was evaluated by 6 panelists in terms of quality of taste (robustness, mellowness, and richness). The evaluation was performed on a scale of 1 to 5 as follows: as compared with the case of Comparative example 4 (control), the case where the quality of each taste was significantly deteriorated was evaluated as 1; the case where the quality of each taste was somewhat deteriorated was evaluated as 2; the case where the quality of each taste was equivalent was evaluated as 3; the case where the quality of each taste was somewhat favorable was evaluated as 4; and the case where the quality of each taste was significantly favorable was evaluated as 5. The results are shown in the following Table 16.

TABLE 16

| | Comparative | Example |
|---|---|---|
| | example 4 | 4-(3) |
| Evaluation item | (control) | (D-psicose) |
| Robustness | 3.0 | 4.3 |
| Mellowness | 3.0 | 4.4 |
| Richness | 3.0 | 4.3 |

As apparent from the obtained scores, it was found that by replacing the total amount of the rock sugar candy by D-psicose, the quality of each taste becomes favorable (Example 4-(3)). In the plum liqueur of Example 4-(3), D-psicose was contained in an amount of 15%, and therefore, it was found that also in the case of an alcoholic beverage having high sweetness, by incorporating D-psicose which is a representative example of rare sugar in an amount of 15%, a sufficient effect of improving the quality of taste can be obtained without deteriorating the balance of the overall quality of taste.

What is claimed is:

1. A method of producing an alcoholic beverage or a beer-flavored beverage, comprising adding an auxiliary material containing rare sugar or rare sugar syrup made from HFCS in the production of an alcoholic beverage or a beer-flavored beverage.

2. The method of producing an alcoholic beverage or a beer-flavored beverage according to claim 1, wherein the auxiliary material containing rare sugar is that contains at least D-psicose, D-allose, or both D-psicose and D-allose.

3. The method of producing an alcoholic beverage or a beer-flavored beverage according to claim 1, wherein the auxiliary material is a rare sugar-containing isomerized sugar which is obtained by isomerizing one or more of the members selected from the group consisting of D-glucose, D-fructose and other isomerized sugars, with 0.005 mol/l or more of an alkali, which auxiliary material contains at least both D-psicose and D-allose, and less than 60% by mass of sugars other than D-glucose or D-fructose.

4. The method of producing an alcoholic beverage or a beer-flavored beverage according to claim 1, wherein the produced alcoholic beverage or beer-flavored beverage contains rare sugar containing at least D-psicose, D-allose, or both D-psicose and D-allose, in an amount of from 0.1 to 20% by mass.

5. The method of producing an alcoholic beverage or a beer-flavored beverage according to claim 1, wherein the alcoholic beverage is a beer.

6. The method of producing an alcoholic beverage or a beer-flavored beverage according to claim 1, wherein the alcoholic beverage or beer-flavored beverage is a low-calorie beer-flavored alcoholic beverage or a low-calorie beer-flavored beverage.

7. The method of producing an alcoholic beverage or a beer-flavored beverage according to claim 1, wherein the produced alcoholic beverage or beer-flavored beverage maintains or improves flavor (mellowness) peculiar to the alcoholic beverage or beer-flavored beverage, and has an excellent overall taste with respect to flavor (mellowness), body (robustness and richness), and sharpness.

8. The method of producing an alcoholic beverage or a beer-flavored beverage according to claim 1, wherein the produced alcoholic beverage or beer-flavored beverage maintains or improves flavor (mellowness) peculiar to the alcoholic beverage or beer-flavored beverage, and has an excellent overall taste with respect to flavor (mellowness), body (robustness and richness) and sharpness, and the deterioration smell generated during storage is reduced or not detected.

9. An alcoholic beverage or a beer-flavored beverage, which maintains or improves flavor (mellowness) peculiar to the alcoholic beverage or beer-flavored beverage, and has an excellent overall taste with respect to flavor (mellowness), body (robustness and richness), and sharpness, containing rare sugar containing at least D-psicose, D-allose, or both D-psicose and D-allose, in an amount of from 0.1 to 20% by mass.

10. An alcoholic beverage or a beer-flavored beverage, which maintains or improves flavor (mellowness) peculiar to the alcoholic beverage or beer-flavored beverage, and has an excellent overall taste with respect to flavor (mellowness), body (robustness and richness), and sharpness, and the deterioration smell generated during storage is reduced or not detected, containing rare sugar containing at least D-psicose, D-allose, or both D-psicose and D-allose, in an amount of from 0.1 to 20% by mass.
